(19) United States
(12) Patent Application Publication
(10) Pub. No.: US 2008/0066324 A1
(43) Pub. Date: Mar. 20, 2008

(54) TOE-KICK SAW BLADE GUARD

(75) Inventors: Lance D. Crain, Fremont, CA (US); Tan D. Nguyen, Milpitas, CA (US); Greg Chambers, Morgan Hill, CA (US)

Correspondence Address: SCHNECK & SCHNECK, P.O. BOX 2-E, SAN JOSE, CA, 95109-0005, US

(73) Assignee: CRAIN CUTTER COMPANY, INC., Milpitas, CA (US)

(21) Appl. No.: 11/850,512

(22) Filed: Sep. 5, 2007

Related U.S. Application Data
(60) Provisional application No. 60/826,349, filed on Sep. 20, 2006.

(51) Int. Cl. B23D 45/16

(52) U.S. Cl. 30/390

(57) ABSTRACT

A toe-kick saw including a rear or front toe-kick wall guide. The toe-kick saw includes a motor contained within said housing, a spindle on the motor, a spindle extension linked to the spindle, a blade mount secured to the spindle extension and a fixed blade guard secured at the end of the spindle extension. The fixed blade guard includes features to enhance safety during tool misuse, such as a rear toe space bumper, a front toe space bumper, primary and secondary blade guards, and a rearward leaning spike. The larger fixed blade guard allows use of a dust port on this tool.

### CROSS-REFERENCE TO RELATED APPLICATION

This application claims priority from U.S. provisional application No. 60/826,349, filed Sep. 20, 2006.

### TECHNICAL FIELD

The present device relates generally to flooring installation tools and more specifically to an improved toe-kick saw having enhanced safety features.

### BACKGROUND

A toe-kick saw is a specialty circular saw used in residential floor remodeling. When a finished floor is to be replaced, this often means that the underlayment beneath the finished floor must also be replaced. The “finished floor” is the topmost, exposed layer of flooring selected for decor and utility in the room (typically vinyl, ceramic tile, carpet, hardwood or laminate plank). Beneath the finished floor is underlayment, which is an especially flat, finely finished material. The use of underlayment ensures the finished floor will be installed on a flat surface with no bumps which might poke through the finished floor or create irregularities. Beneath the underlayment is the rough subfloor (normally plywood) which is laid over the joists.

When a finished floor is to be replaced, it is often necessary to replace the underlayment as well. When new vinyl, ceramic tile, or hardwood floors are installed, adhesive is used to adhere the finished floor to the underlayment. In such cases, the finished floor cannot be removed from the underlayment without damaging it.

In many finished floor installations, especially in kitchens and bathrooms, cabinetry is encountered which may have toe-kicks. Toe-kicks are relieved areas at the bottom of the cabinet which allow a person to step closely to the cabinet without stubbing a toe. Often times the cabinetry is installed first before the finished floor is installed, and the cabinetry is installed on top of the underlayment. In the case of a hardwood finished floor, the cabinetry may even be installed on top of the finished floor as well.

Whenever cabinets with toe-kicks are installed on top of the underlayment or finished floor, removing only old underlayment and/or finished floor under the toe-kick can be very difficult. Using conventional hand tools, such as a hammer and chisel, the floor installer would have to chisel out the floor along the entire length of the toe-kick. This chiseling is difficult because the chisel can only be pointed into the corner at a 45 degree angle, not straight downward as required to effectively chisel the material. There is a clear danger of the hammer or chisel striking and damaging the cabinet face. Conventional power saws will not fit underneath the toe space. A specialized power saw is needed which can extend underneath and cut flush up against the inner wall of a toe space.

Toe-kick saws are available for this purpose. As shown in FIG. 1, a typical prior art toe-kick saw 100 consisted of a circular saw motor 120 having a rotating armature (not shown), a primary spindle 140 operatively coupled to the armature, and a means to extend the spindle 150. With respect to the means to extend the spindle, and in regard to both prior art toe-kick saws as well as those of this invention, the preferred means to extend the spindle has included a separate assembly, which will be referred to herein as a “spindle extension assembly” or as a “spindle extension.” However, a separate assembly need not be used. For example, the spindle itself may be elongated. For this reason, the terms elongate spindle, a spindle extension assembly, or a spindle extension shall all be defined and used herein as a means to extend the spindle.

The spindle extension assembly 150 of prior art toe-kick saw 100 includes spindle coupler 160, secondary spindle 200, and set screw 180 which connects spindle coupler 160 and secondary spindle 200. Other means to extend the spindle may be created by persons skilled in the art. For example, a spindle extension may be inserted into a hole in the spindle gear itself and keyed to a slot in the spindle gear. All such will be defined herein as a spindle extension assembly or spindle extension.

With reference to the prior art toe-kick saw 100 of FIG. 1, housing 400 functions to cover the rotating spindle extension assembly 150 and connect saw blade 300 to secondary spindle 200. Housing 400 includes face plate 220, tube 240, fixed guard 260, movable guard 280, a blade driver 320 (behind the blade 300), a small circular saw blade 300, and a countersunk pan head blade screw 340. Housing 400 is screwed onto saw motor 120 using four screws 350. When motor 120 and primary spindle 140 turn, spindle extension assembly 150 turns, thereby turning blade driver 320 and blade 300. Toe-kick saw 100 can thus enter a toe-kick and cut flush up to its inner wall. The saw is guided along the inner wall of the toe-kick by the edges 360 of fixed guard 260. Edges 360 extend approximately 1/16″ past the vertical plane defined by blade 300 to prevent blade 300 and countersunk screw 340 from rubbing against the inner wall of the toe-kick. Edges 360 thus place blade 300 as close as possible to the inner wall of the toe-kick, thus cutting off as much of the old flooring material as possible.

The prior art toe-kick saw 100 has a fixed guard 260 which is as small as possible in order to fit in as wide a range of toe-spaces as possible. A small blade guard 260, 280 also enables toe-kick saw 100 to come as close as possible to a wall surface of the room which may abut the toe-kick (such as, an inside corner area). However, users commonly misuse toe-kick saws. Despite instructions for proper usage and warnings to use the saw underneath toe-spaces only, and to cut forward and straight along the inner wall of the toe-space only, users misuse the tool by cutting outside the toe-space, by cutting sharp curves, or even by running the saw backwards by pulling it towards themselves. Such abuse may create the dangerous and well-known hazard common in the use of all circular saws called saw kickback. Saw kickback is caused when a saw blade may catch or become wedged on the edges of a saw kerf. The sudden stoppage of the blade may cause the saw to launch itself backward towards the user, creating a laceration hazard.

The fixed guard 260 does little to prevent saw misuse. While its small size is preferred, edges 360 are thin (0.160 inch or thinner) and do little to guide the saw straight forward or prevent it from being turned sharply. For this reason, fixed guard 260 will be defined herein as primarily a structure which “defines a blade housing.”

To prevent saw misuse, and provide additional safety in the case of saw misuse, features may be added to the fixed guard 260. Forward or rearward horizontal projections from the fixed guard 260 having wider flat surfaces could provide better guidance. Such wider flat surfaces might also prevent the saw from being turned sharply when they are flush against the inner wall of a toe-kick as prescribed for safe usage. Such wider flat surfaces may be designed so that they do not extend past the handles of the saw. Thus, they would not hinder the saw when it is started (or approaches) a wall abutting the toe-kick. Such a rearward or forward projection will be referred to herein as a rear toe-kick wall guide or a front toe-kick wall guide, respectively.

Other additional safety mechanisms may be mounted on a rear toe-kick wall guide or a front toe-kick wall guide, which were not possible before on prior art saws. Gripping devices may also be added to the movable guarding mechanisms to make it more difficult to pull the saw backwards towards the user.

It is an object of one or more embodiments to provide an improved blade guard for a toe-kick saw which provides improved guidance for the saw for straight cutting and prevents sharp turns when the saw is used as prescribed under a toe-kick.

It is an object of one or more embodiments to provide an improved blade guard for a toe-kick saw which may provide additional guarding in the event of saw kickback.

It is an object of one or more embodiments to provide an improved blade guard with a means of covering the circular saw blade, where said blade in previous saws was completely exposed.

It is an object of one or more embodiments to provide a means on the guarding mechanism to ensure that the saw is always pushed by a user in a direction which is forward or against the rotation of the circular saw blade.

It is an object of one or more embodiment to provide an improved blade guard for a toe-kick saw which allows the mounting of additional safety features, including an extended bumper surface, a secondary blade guard, and a dust control port.

### SUMMARY

The above objects have been achieved with an improved blade guard for a toe-kick saw having a fixed blade guard with either or both a rear toe-kick wall guide or a front toe-kick wall guide. Such a rear toe-kick wall guide or front toe-kick wall guide may also include an elongate flat surface which contacts flush against the inner wall of the toe space. Such a flat surface may assist in straight cutting and prevent the saw from making sharp turns. The rear toe-kick wall guide may also include a second surface which aids to deflect the saw away from a user in the event the saw kicks back and contacts the user, thus providing greater protection in the event of saw kickback.

On the fixed blade guard, a secondary retractable blade guard may be mounted. Such a secondary retractable blade guard may provide greater protection in the event of saw kickback by extending below the bottom edge of the fixed guard. Such a secondary retractable blade guard may also extend beyond the radius of the primary retractable blade guard to ensure that the primary retractable blade guard always has ample clearance to fully extend.

Onto either of the primary or secondary retractable blade guards, a gripping mechanism (e.g., such as rearward leaning spikes) may be mounted, which may prevent the saw from being moved backward (in a direction that is not against the rotation of the circular saw blade). Such spikes may dig into a floor surface to prevent the saw from being moved backward. The fixed blade guard may also include a dust port.

### BRIEF DESCRIPTION OF THE DRAWINGS

FIG. 1 is a partially exploded view of prior art toe-kick saws.

FIG. 2 is a detailed exploded view of a toe-kick saw with improved blade guard.

FIG. 3 is a second detailed exploded view of the saw of FIG. 2 as viewed from the opposite direction to show additional features of an improved blade guard.

FIG. 4 is an assembled view of a toe-kick saw with an improved blade guard.

FIG. 5 is a front view of an alternative embodiment of a toe-kick saw which, in addition to having a rear toe-kick wall guide with an elongate flat area, also has a front toe-kick wall guide with a forward elongate flat area.

FIG. 6 is a side perspective view of the toe-kick saw having alternative embodiment of the rear toe-kick wall guide with a wider extended bumper surface.

FIG. 7 is a front view of an alternative embodiment of a toe-kick saw which includes a face plate covering the saw blade.

FIG. 8 is a rear perspective view of an alternative embodiment of a toe-kick saw which, in addition to having a rear toe-kick wall guide, also includes a dust control port.

FIG. 9 is a front view of an alternative embodiment of a toe-kick saw in which the primary movable guard has a spike which prevents the saw from being moved in a reverse direction, when the primary movable guard is in extended position.

FIG. 10 shows the primary movable guard of FIG. 9 in a retracted position.

### DETAILED DESCRIPTION OF THE INVENTION

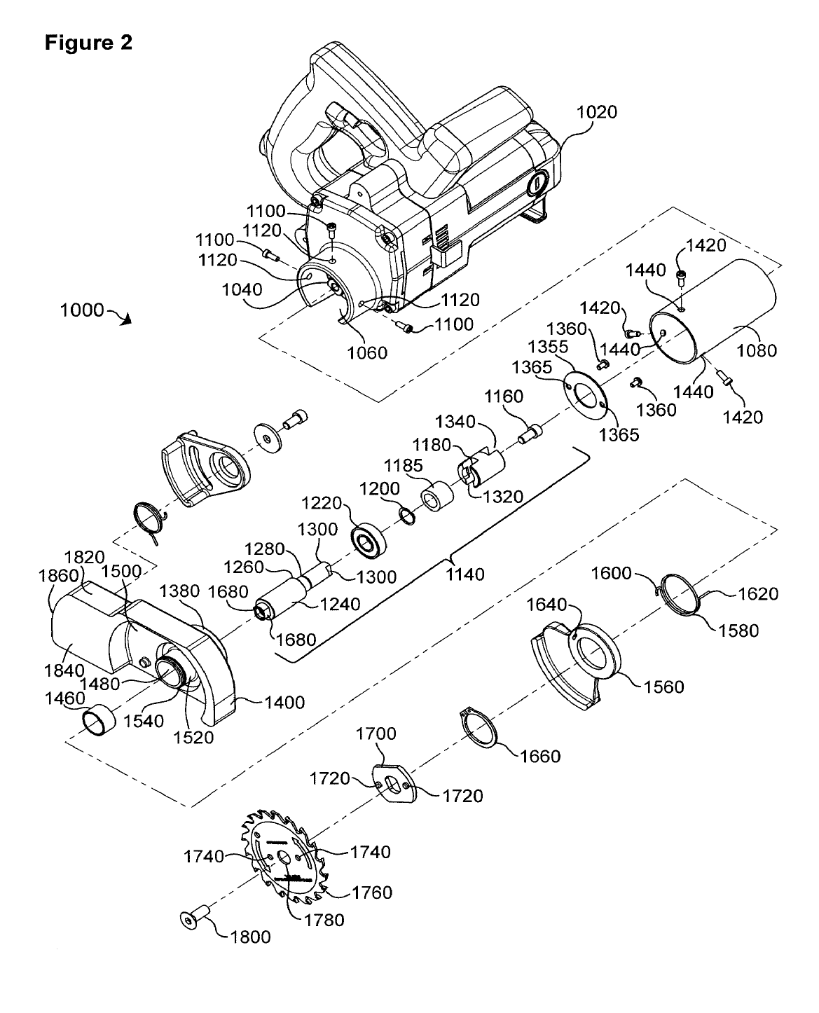

With reference to FIG. 2, toe-kick saw 1000 consists of a circular saw motor 1020 having an internal rotating armature (not shown) operatively coupled to a rotating spindle 1040. The housing of motor 1020 has an opening 1060 which accepts tube 1080. Tube 1080 is inserted and fastened into opening 1060 with three screws 1100 which run through three holes 1120.

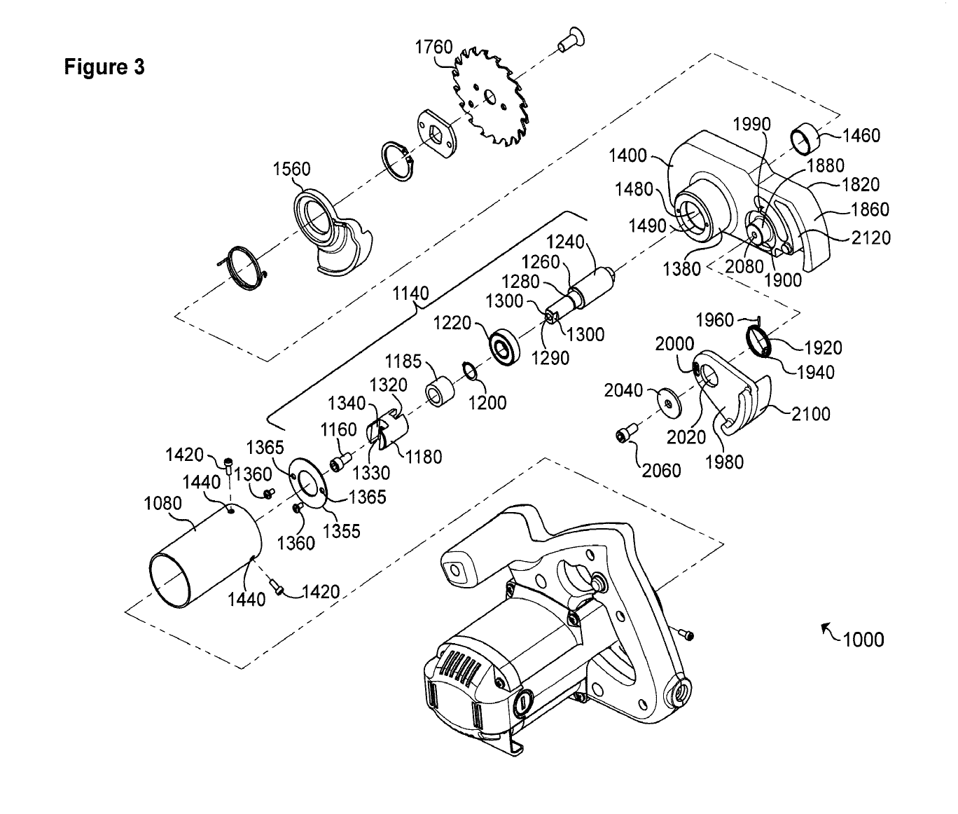

As shown in FIGS. 2 and 3, tube 1080 serves to house spindle extension assembly 1140. Spindle extension assembly 1140 includes screw 1160, spindle coupler 1180, spacer 1185, snap ring 1200, ball bearing 1220, and secondary spindle 1240. The assembly of these components goes as follows: Ball bearing 1220 is slipped onto secondary spindle 1240 and rests on shoulder 1260. Snap ring 1200 is seated in groove 1280. Spacer 1185 is then slipped onto secondary spindle 1240.

Next in the assembly is the mounting of spindle coupler 1180. Spindle coupler 1180 has a slot 1320 which accepts flats 1300 on secondary spindle 1240. As shown in FIG. 3, spindle coupler 1180 has a slot 1340 on the opposite end and a hole 1330 through its centerline. Screw 1160 goes through this centerline hole 1330 and fastens into a tapped centerline hole 1290 on the inside end of secondary spindle 1240.

As shown in FIG. 2, once spindle coupler 1180 is fixed onto secondary spindle 1240, it may form a coupling for spindle extension assembly 1140 when slot 1340 is coupled to spindle 1040 (of motor 1020). When connected in this manner, spindle extension assembly 1140 is capable of transmitting rotational force from saw motor 1020 to a blade driver at an extended distance.

Spindle extension assembly 1140 is housed within tube 1080. As previously explained, tube 1080 is inserted and fastened into opening 1060 of saw motor 1020. As shown in FIGS. 2 and 3, on the opposite end, tube 1080 is press fit onto boss 1380 on the back side of fixed guard 1400 and fastened with three screws 1420 through three holes 1440.

Internal support for spindle extension assembly 1140 is provided within fixed guard 1400 by ball bearing 1220 and bushing 1460. Bushing 1460 is press fit into a reamed counterbored hole 1480. As shown in FIG. 3, hole 1480 runs all the way through to the opposite side of fixed guard 1400, where counterbore 1490 is located. Spindle extension assembly 1140 is then inserted though this back side of hole 1480 and bushing 1460 until ball bearing 1220 seats in counterbore 1490. As shown in FIGS. 2 and 3, plate 1355 is placed on top of ball bearing 1220. Two screws 1360 are fastened into fixed guard 1400 through two holes 1365 in plate 1355. As shown in FIG. 3, this fastens ball bearing 1220 into counterbore 1490 and secures spindle extension assembly 1140 into fixed guard 1400.

When ball bearing 1220 is seated and fastened into counterbore 1490, the secondary spindle is prevented from sliding out by snap ring 1200. Spacer 1185 provides additional safety should snap ring 1200 fail. Spacer 1185 is larger in outside diameter than the center hole in ball bearing 1220, and thus also prevents spindle extension assembly 1140 from sliding out.

Practical problems of imprecise bearing alignment, runout, and motor vibration make manufacturing a circular saw with an extended spindle difficult. As shown in FIG. 2, connecting a separate secondary spindle (such as secondary spindle 1240 to the motor by way of spindle coupler 1180 is preferred because a controllable amount of play is allowed in the juncture between slot 1340 and primary spindle 1040. Without such play, even slight misalignment will result in runout or wobbling forces being transferred to ball bearing 1220 and bushing 1460. This reduces the life of the saw.

As shown in FIG. 2, fixed guard 1400 has a blade housing 1500 which contains cylindrical guard mount 1520. As with prior art toe-kick saws, a torsion spring 1580 and movable guard (hereinafter, the “primary movable guard” 1560) is placed onto cylindrical guard mount 1520. Torsion spring 1580 hooks on end 1620 into a hole inside blade housing 1500 (not shown) and on hook 1600 to a hole 1640 on primary movable guard 1560. When primary movable guard 1560 is retracted (as during a cutting operation), tension builds in torsion spring 1580 which urges primary movable guard 1560 to re-extend back to a forward guarding position. Cylindrical guard mount 1520 has snap ring groove 1540. Snap ring 1660 is seated into snap ring groove 1540 to hold primary movable guard 1560 and torsion spring 1580 in place.

The distal end of secondary spindle 1240 projects a sufficient distance into blade housing 1500 to expose flats 1680. Flats 1680 engage blade driver 1700 which has a pair of cylindrical projections 1720. Cylindrical projections 1720 engage drive holes 1740 of small circular saw blade 1760. Small circular saw blade 1760 has an arbor hole 1780 which is precision countersunk on its outside surface to seat the pan-shaped head of blade screw 1800. Because blade screw 1800 is fully recessed into countersunk arbor 1780, the small circular saw blade 1760 has a flush face, and is able to cut as closely as possible to the inner wall of a toe-kick.

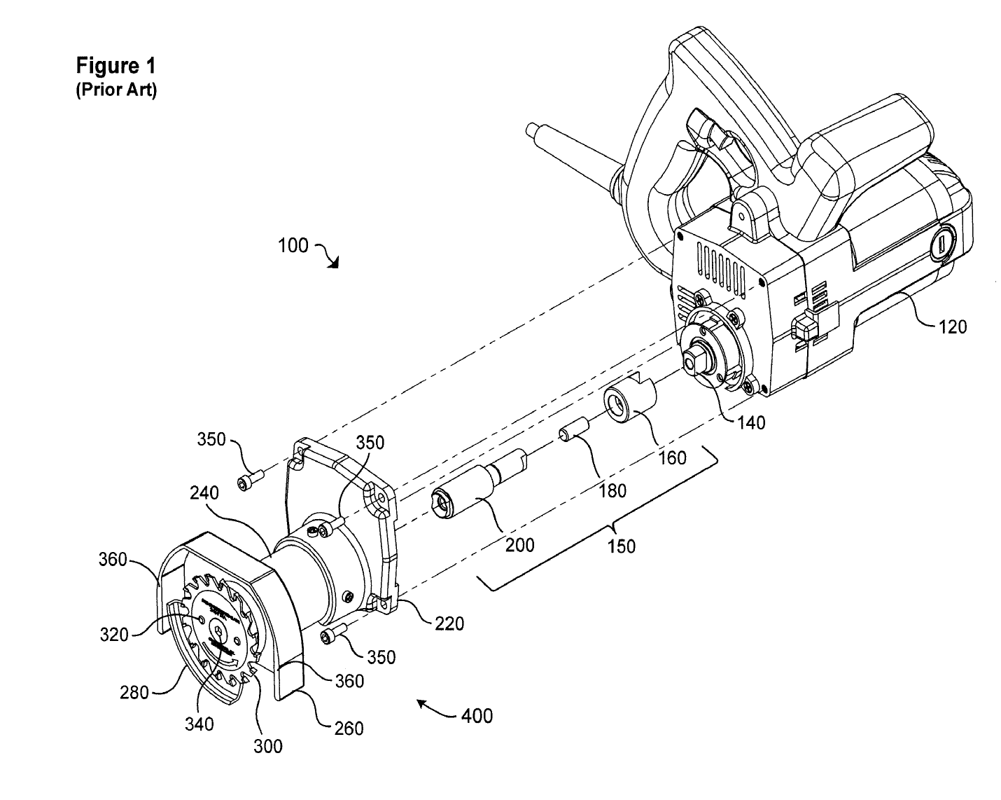

Fixed guard 1400 shows a new element, rear toe-kick wall guide 1820, which has an elongate flat area 1840. Elongate flat area 1840 serves as an improved guidance surface compared to edges 360 (FIG. 1) of the prior art toe-kick saw. As shown in FIG. 2, elongate flat area 1840 guides toe-kick saw 1000 when elongate flat area 1840 contacts flush against the inside wall surface of a toe-kick. Such a large flat surface is far superior than the thin edges 360 (FIG. 1) for this purpose. Elongate flat area 1840 will also contact the inner wall of the toe space if the saw is turned too rapidly in an attempt to steer the saw out of the toe space while cutting. Thus, elongate flat area 1840 makes rear toe-kick wall guide 1820 preferred for two important safety reasons.

A “front/rear toe-kick wall guide” or “rear toe-kick wall guide” will be further defined as a portion of a fixed blade guard that is short enough to fit within a toe-kick and extends horizontally left or right more than ¼″ inch from either inside wall of the blade housing located within the fixed blade guard. Such a feature performs an additional function of providing guidance for the saw (i.e. it does not merely “define a blade housing” which is the primary function of the fixed guard). Such a front or rear toe-kick wall guide has an elongate wall engaging side face, allowing it to act as a guide against the inside wall of the toe-kick. It is preferred that said wall engaging side face be parallel with plane defined by the outer, vertical face of the circular saw blade. However, said wall engaging side face may also be at an angle in relation to the plane defined by the blade and be equally effective at preventing sharp turns, forming an extended bumper surface, or enabling the mounting of a secondary blade guard. The additional functions of the rear toe-kick wall guide will be more fully explained in the following.

Rear toe-kick wall guide 1820 also forms an extended bumper surface 1860 which is at a distance from blade housing 1500. As shown in FIGS. 2 and 3, extended bumper surface 1860 will help keep small circular saw blade 1760 away from the user in the event of saw kickback. This makes rear toe-kick wall guide 1820 preferred for a third safety reason.

As shown in FIG. 3, the rear toe-kick wall guide 1820 has on its opposite side a second, cylindrical guard mount 1880 with a snap ring groove 1900. This is for rotatably mounting a secondary movable guard 1980 in a similar manner to primary movable guard 1560. Torsion spring 1920 is placed on second cylindrical guard mount 1880 and arm 1960 is hooked into slot 1990 in rear toe-kick wall guide 1820. Torsion spring 1920 is connected to secondary movable guard 1980 by inserting hook 1940 into spring hole 2000. Secondary movable guard 1980 is then mounted on second cylindrical guard mount 1880 through mounting hole 2020. When secondary movable guard 1980 is retracted (as during a cutting operation), tension builds in torsion spring 1920 which urges secondary movable guard 1980 to re-extend back to a forward guarding position. Secondary movable guard 1980 is fastened onto rear toe-kick wall guide 1820 by washer 2040 and screw 2060 which is screwed into tapped hole 2080 of rear toe-kick wall guide 1820.

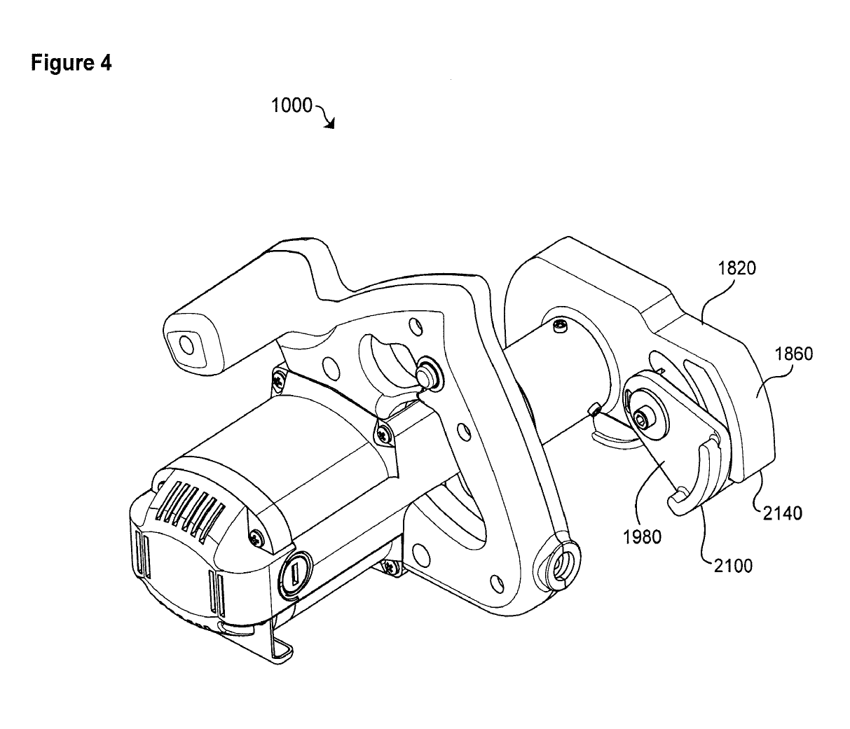

Secondary movable guard 1980 has a bumper surface 2100 which is retracted into slot 2120 of rear toe-kick wall guide 1820 during a cutting operation. If toe-kick saw 1000 should kick back, secondary movable guard 1980 will extend automatically, and bumper surface 2100 will provide additional protection for the user. As shown in FIG. 4, bumper surface 2100 of secondary movable guard 1980 extends below bottom edge 2140 of the bumper surface 1860 of rear toe-kick wall guide 1820. If toe-kick saw 1000 kicks back, it rises out of the cut and off of the floor. Secondary movable guard 2100 would then automatically extend down into a guarding position. Therefore, rear toe-kick wall guide 1820 is preferred for a third safety reason: It enables the addition of a new element, secondary movable blade guard 1980.

An improved blade guard for a toe-kick saw having a front toe-kick wall guide or a rear toe-kick wall guide may have alternative embodiments. As previously explained, as shown in FIG. 2, elongate flat area 1840, serves as an improved guidance surface compared to edges 360 (FIG. 1) of the prior art toe-kick saw. Elongate flat area 1840 guides against the flat inner wall of the toe-kick, and also prevents the saw from being turned rapidly should the user attempt to make a tight radius cut in order to remove the saw from the toe-kick.

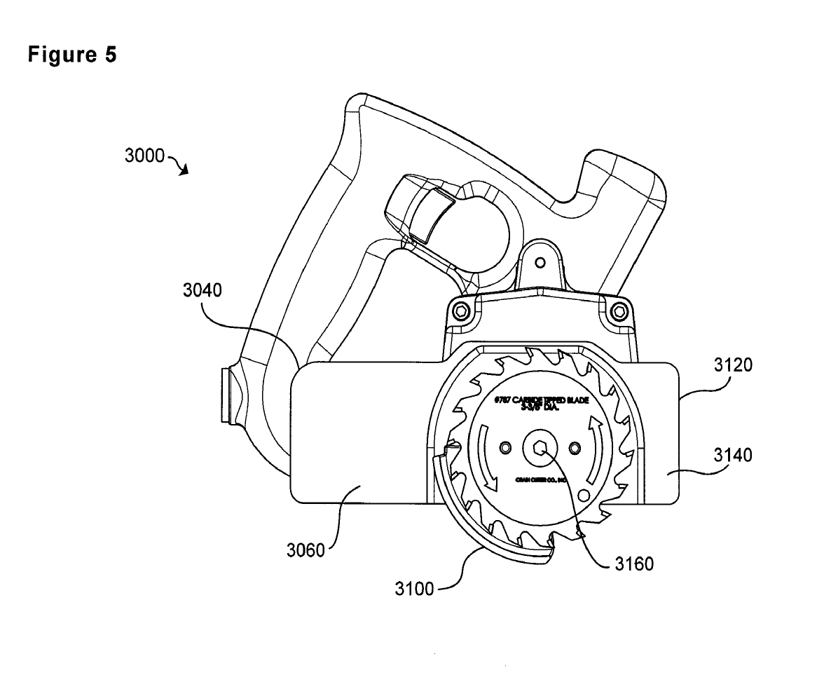

In one alternative, as shown in FIG. 5, toe-kick saw 3000 has an additional front toe-kick wall guide 3120 and forward elongate flat area 3140. Forward elongate flat area 3140 may interact with elongate flat area 3060 on rear toe-kick wall guide 3040 to create an improved guidance surface. When toe-kick saw 3000 is used against the inner wall of a toe-kick, both elongate flat surfaces 3060, 3140 will interact to guide the saw along the wall and prevent the saw from pivoting either forward or backward in relation to the spindle axis (centered at clamp 3160). This reduces the possibility that toe-kick saw 3000 can be turned sharply in either direction when used against the inner wall of a toe-kick. A front toe-kick wall guide and forward elongate flat area may be added to any of the embodiments.

In another embodiment, the front toe-kick wall guide and rear toe-kick wall guide are shorter in their horizontal extension (as measured by their horizontal extension from the centerline of the spindle extension assembly) than the horizontal extension of the saw's handles. Such would be preferred so that the saw can cut as far as possible into a corner area where a wall may abut the toe-kick. Such a feature may be adapted to become a part of any of the embodiments.

In another embodiment, the secondary movable guard may have a longer radial extension than that of primary movable guard. This would ensure that whenever the secondary movable guard could extend into a fully extended guarding position, the primary movable guard would be unimpeded in its ability to extend. Making the secondary blade guard longer in radial extension would help ensure that the primary blade guard has adequate clearance to fully extend. Such is preferred and may become a part of any of the embodiments.

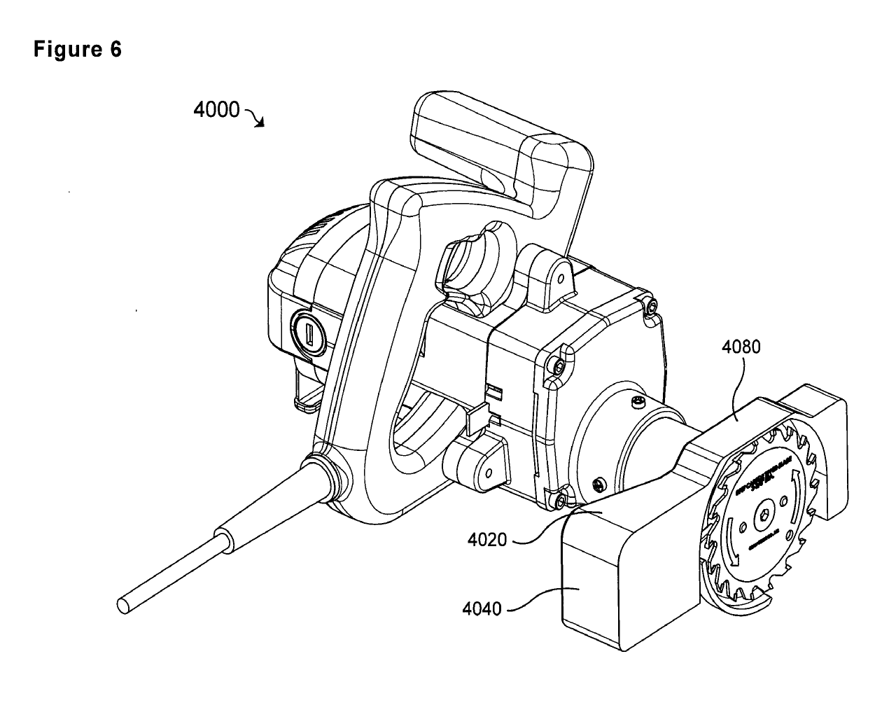

In FIG. 6, an alternative embodiment of an extended bumper surface is shown. Toe-kick saw 4000 has a rear toe-kick wall guide 4020 and a wider extended bumper surface 4040 which is wider than the blade housing area 4080 in order to create a wider surface to protect the user in the event of saw kickback. A wider extended bumper surface 4040 may increase the probability that the toe-kick saw will be stopped by the contact with the user and that the blade will be kept at a distance from the user's body, reducing the chances of injury. Such a wider extended bumper surface may be added to any of the embodiments herein to increase its effectiveness.

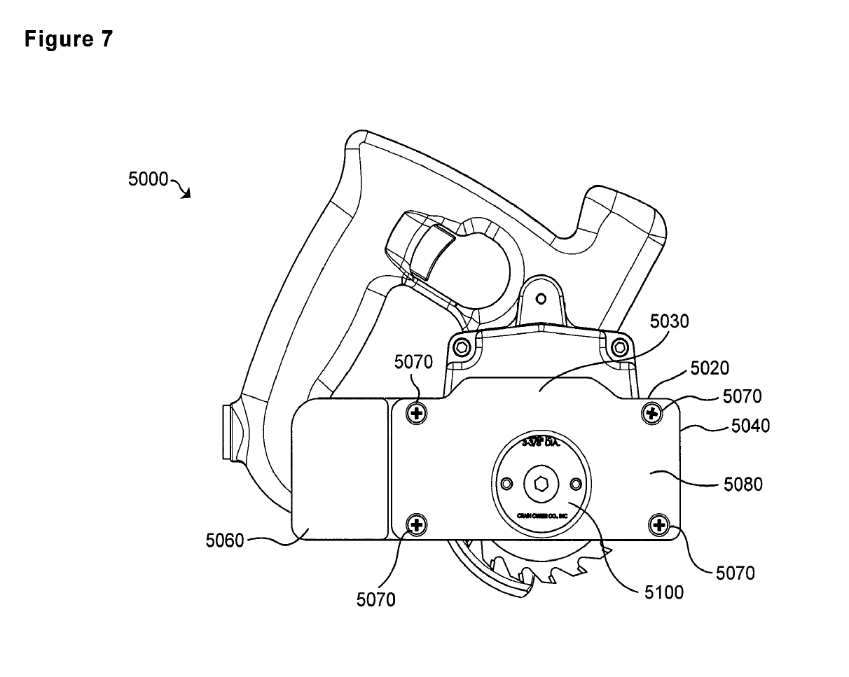

In FIG. 7, an alternative embodiment of the fixed guard is shown with an additional face plate. As shown in FIG. 7, toe-kick saw 5000 has a fixed guard 5020 with a front toe-kick wall guide 5040 and a rear toe-kick wall guide 5060. A portion of the outer, wall running surface of blade housing, front toe-kick wall guide 5040, and rear toe-kick wall guide 5060 may be recessed to flush mount face plate 5080. Fixed guard 5020 may have four tapped countersunk holes for receiving four pan head screws 5070 which may hold face plate 5080 in place. A face plate may be mounted on a toe-kick saw by other means, even on the prior art toe-kick saw (FIG. 1), or any other of the embodiments described herein. However, the flush mounting method of FIG. 7 is preferred. This is because the front toe-kick wall guide 5040 and rear toe-kick wall guide 5060 provide large, flat surfaces which help prevent bending of face plate 5080 and allow larger holes for screws to mount face plate 5080. Face plate 5080 reduces the risk that saw blade 5100 will cut or snag unintended items if the saw kicks back.

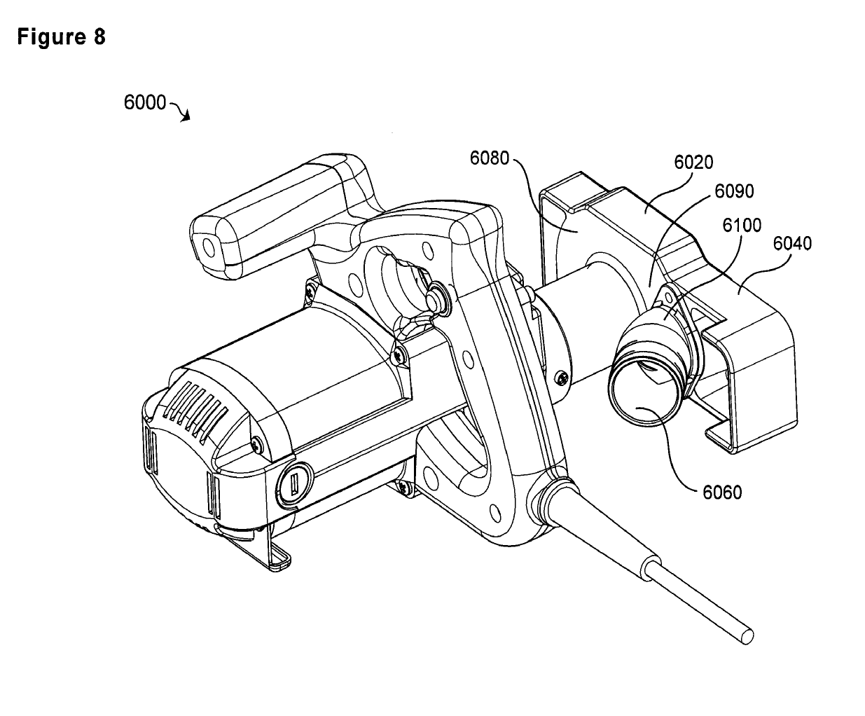

In FIG. 8, an alternative embodiment of the fixed guard is shown having an alternative rear toe-kick wall guide which includes a dust control port 6060. Toe-kick saw 6000 has a fixed guard 6020 with a rearward projection 6040 which has dust control port 6060. Blade housing 6080 may have an opening through its back side 6090. This opening may be covered by a shroud 6100 which is designed to connect with common shop vacuums. Such a shroud may include a cap (not shown) to cover opening 6060 when a vacuum is not in use. A rear toe-kick wall guide enables the mounting of a shroud such as shroud 6100. A rear toe-kick wall guide containing a dust control port may be added to any of the embodiments to enable the use of a vacuum for dust control.

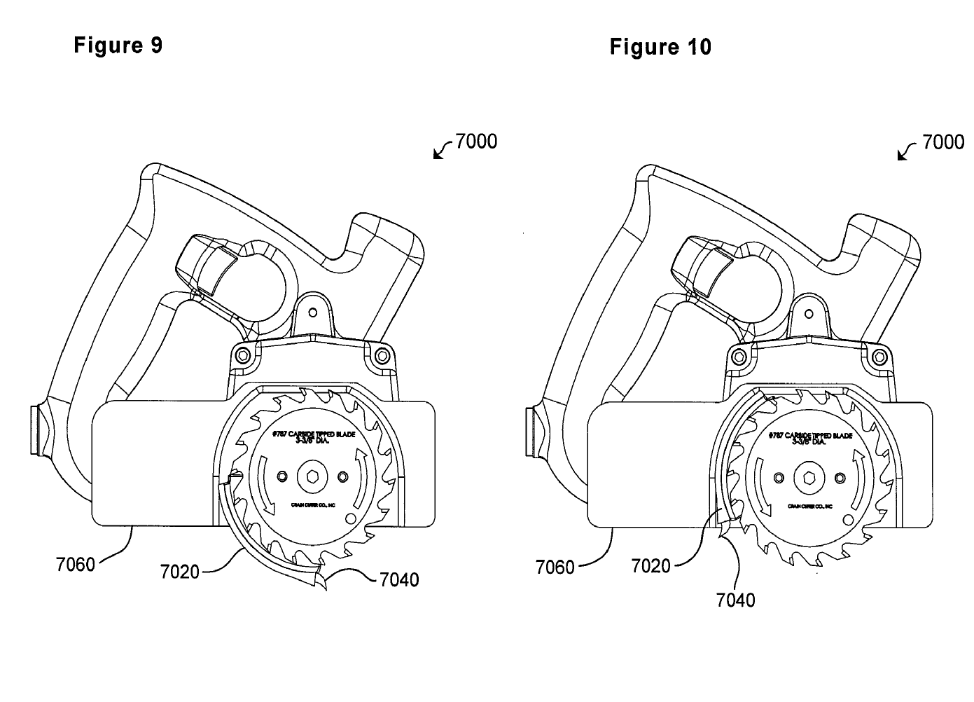

In FIG. 9, an alternative embodiment of a primary movable guard is shown with an added spike. Toe-kick saw 7000 has a primary movable guard 7020 with a rearward leaning spike 7040. As shown in FIG. 10, primary movable guard 7020 may retract to a position which enables a rearward leaning spike 7040 to contact the floor below. If the user pulls the toe-kick saw 7000 backwards (i.e., with the blade rotation), rearward leaning spike 7040 will stick in the floor and stop the saw from moving further backward. As previously explained, pulling the saw in reverse can be a cause of saw kickback. Rearward leaning spike 7040 may be added to either a primary movable guard (such as primary movable guard 1560 of FIG. 2) or a secondary movable guard (such as secondary movable guard 1980 of FIG. 3) to reduce this potential kickback hazard.

Putting the spike on a movable guard is preferred because it does not create a surface which is not flat on base 7060 of the fixed guard. If this base is not a flat surface, the blade is easily turned and wedged during use, promoting saw kickback. Furthermore, the saw would not cut to proper depth.

Such a spike or other frictional means to prevent the toe-kick saw from being moved backwards may be added to any of the embodiments herein to reduce the kickback hazard.

What is claimed is:

1. A toe-kick saw, comprising:
a saw motor having a spindle;
a spindle extension;
a blade mount operatively coupled to said spindle extension;
a tube section extending from said saw motor which covers said spindle extension;
a fixed blade guard on a first end of said tube section which defines a blade housing; and
a rear toe-kick wall guide on said fixed blade guard.

2. The toe-kick saw of claim 1, further including a movable blade guard mounted on the fixed blade guard.

3. The toe-kick saw of claim 1, further including a front toe-kick wall guide on the fixed blade guard.

4. The toe-kick saw of claim 1, further including a rearward leaning spike mounted at a terminal edge of the movable blade guard.

5. The toe-kick saw of claim 1, further including a face plate.

6. The toe-kick saw of claim 1, further including a dust control port.

7. The toe-kick saw of claim 1, further including a primary movable blade guard and a secondary movable blade guard.

8. The toe-kick saw of claim 7, further including a rearward leaning spike mounted on at least one of said primary movable blade guard and said secondary movable blade guard.

9. A toe-kick saw, comprising:
a saw motor having a spindle;
a spindle extension mounted on said spindle;
a blade mount on said spindle extension;
a tube section extending from said saw motor which covers said spindle extension;
a fixed blade guard mounted on an end of said tube section which defines a blade housing; and
a face plate over a front of said fixed blade guard.

10. The toe-kick saw of claim 9, further including either a front toe-kick wall guide or a rear toe-kick wall guide.

11. The toe-kick saw of claim 9, further including a movable blade guard mounted on said fixed blade guard.

12. The toe-kick saw of claim 11, further including a rearward leaning spike mounted on a terminal edge of said movable blade guard.

13. A toe-kick saw, comprising:
a saw motor having a spindle and enclosed by a housing;
a spindle extension mounted on said spindle;
a blade mount operatively coupled to said spindle extension;
a tube section mounted on the housing, said tube section covering said spindle extension;
a fixed blade guard mounted on a first end of said tube section which defines a blade housing; and
a movable blade guard having a spike which is positioned and angled to stop the saw if it is pulled in a direction opposed to a tangential direction of a lower most portion of the spindle.

14. The toe-kick saw of claim 13, further including either a front toe-kick wall guide or a rear toe-kick wall guide mounted on said fixed blade guard.

15. A toe-kick saw, comprising:
a saw motor having a spindle and enclosed by a housing;
a spindle extension coupled to said spindle;
a blade mount operatively coupled to said spindle extension;
a tube section mounted on the housing, said tube section covering said spindle extension;
a fixed blade guard mounted on an end of said tube section which defines a blade housing;
a primary movable blade guard, rotatably mounted on said fixed blade guard; and
a secondary movable blade guard, rotatably mounted on said fixed blade guard.

16. The toe-kick saw of claim 15, where said fixed blade guard includes a rear toe-kick wall guide, and said secondary movable blade guard is mounted on said rear toe-kick wall guide.
